(19) United States
(12) Patent Application Publication
(10) Pub. No.: US 2013/0299031 A1
(43) Pub. Date: Nov. 14, 2013

(54) Air Controller

(71) Applicant: Gregory Johnson, Richfield, MN (US)

(72) Inventor: Gregory Johnson, Richfield, MN (US)

(21) Appl. No.: 13/469,467

(22) Filed: May 11, 2012

(51) Int. Cl. F16L 57/06

(52) U.S. Cl. 138/103

(57) ABSTRACT

An air controller comprises a shield adapted to be disposed around pipes, the shield may include at least one layer having an elongated surface, the surface having at least one geometrical pattern mounted on the surface and substantially covering a portion of the surface. The pattern may include an effective number of plurality of laterally extending repeating elements, wherein the elements are directly applied to the pipes creating plurality of contact surfaces effective to control flow of air from the pipes.

### FIELD

This invention is generally related to devices that regulate flow of air in industrial systems.

### BACKGROUND

Air leak is a common event in compressed air systems. Leaks may occur in mechanical seals, threaded fittings, sealants, gaskets, structural gaps and other parts of machinery. Leaks comprise a significant source of lost energy in compressed air systems, often wasting as much as 20-30% of the compressor's output, in some systems.

When a leak is detected, the pressure is typically shut down to enable the maintenance crew to identify the source of the leak and tighten the pipes. The crew may also replace connections and pipes to close the leak. The repair process itself needlessly squanders resources and productivity of the system until the leak source is pinpointed and repaired. In large systems, the loss of productivity and energy increase exponentially when the pressure is shut down. Identifying the source leak in a large system is a cumbersome and time-consuming process. Therefore there is a need for an invention that repairs the air leak while the system is running and functioning. This invention provides such advantage and others as provided here.

### SUMMARY

The invention is directed to an air controller that includes a shield adapted to be disposed around pipes. The shield includes at least one layer having an elongated surface and may be made of nitrille rubber or other materials. The surface may have at least one pattern mounted on the surface and substantially covering the surface. The pattern may include an effective number of plurality of laterally extending repeating elements. The elements may be directly applied to the pipes to create plurality of effective contact surfaces to control flow of air from the pipes. The elements may include uniform dimensional cubes substantially covering the surface of the shield or a portion of the surface.

Other systems, methods, aspects, features, embodiments and advantages of the invention disclosed herein will be, or will become, apparent to one having ordinary skill in the art upon examination of the following drawings and detailed description. It is intended that all such additional systems, methods, aspects, features, embodiments and advantages be included within this description, and be within the scope of the accompanying claims.

### BRIEF DESCRIPTION OF THE DRAWINGS

It is to be understood that the drawings are solely for purpose of illustration. Furthermore, the components in the figures are not necessarily to scale, emphasis instead being placed upon illustrating the principles of the system disclosed herein. In the figures, like reference numerals designate corresponding parts throughout the different views.

FIG. 1 shows an exemplary embodiment in accord with the present invention;

FIG. 2 is a horizontal cross section through the embodiment shown in FIG. 1; and

FIG. 3 is a side view of the embodiment shown in FIG. 1.

### DETAILED DESCRIPTION

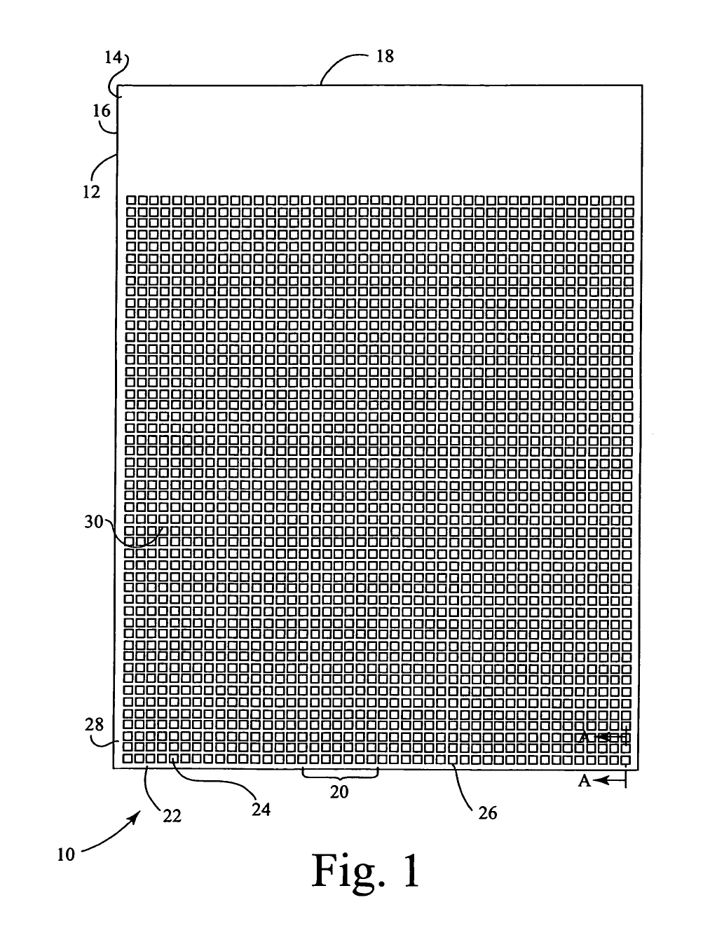

FIG. 1 shows an exemplary embodiment in accord with the present invention. Air controller 10 may be in the form of a longitudinal layer 12 or plurality of layers. Layer 12 has a wide surface area 14, width 16, and height 18. Layer 12 may be made of polymers, or starting materials that include cyano functional groups, or other suitable materials. Surface area 14 may include plurality of elements 20 that may substantially cover portions of surface area 14. Elements 20 may be of variety of shapes and variety of geometrical patterns. Experiments have shown that elements 20 are preferably in the form of cubes 22 laterally extending from surface 14. Cubes 22 were found to create effective mini contact surfaces 24 with pipes to seal off air or fluid leaks of pneumatic pipes. Elements 20 may form units 28 of pattern 30. Pattern 30 may comprise repeating elements 20 of uniform dimensions or may be comprised of variety of dimensions.

With either a change in bonding material or change in base compound, air controller 10 may be used in many other applications as a stop leak device. Air controller 10 may have viability when made out of nano-material in many medical device applications.

Air controller 10 may be preferably 12 inches by 16 inches and may or may not have an extension of stainless steel wire mesh imbedded in surface area 14. It may be of any color and may be made of nitrile rubber compound. The compound may be either 40 to 60 durometer in hardness and may have a temperature range of −40 to 250 Fahrenheit.

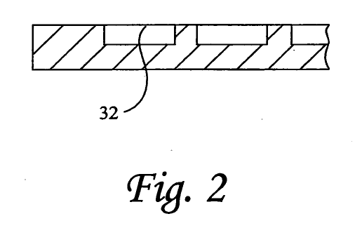

FIG. 2 is a cross section A-A cut through surface area 14, which shows cavities 30 through elements 20. Elements 20 may have same dimensions or different dimensions. Many factors affect the design criteria of elements 20 including the particular shape, size, dimensions of pneumatic pipes, and the pressure in the pneumatic system.

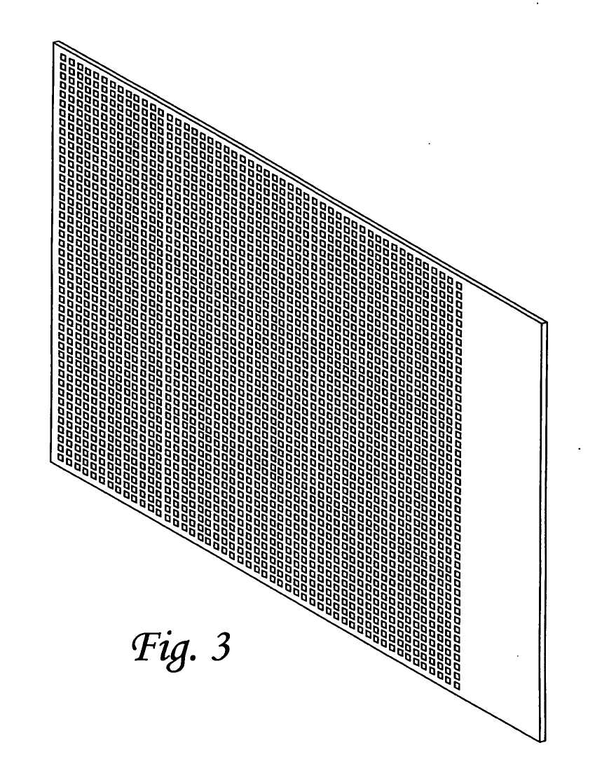

FIG. 3 shows a different view of FIG. 1 and illustrates one aspect of the present invention. The present invention significantly reduces and blocks compressed air leaks. Compressed air leaks are a significant source of wasted energy in compressed air system, often wasting as much as 20-30% of the compressor's output. Compressed air leaks can also contribute to problems with system operations, including fluctuating system pressure, which can cause air tools and other air-operated equipment to function less efficiently, possibly affecting production; excess compressor capacity, resulting in higher than necessary costs; decreased service life and increased maintenance of supply equipment, including the compressor package, due to unnecessary cycling and increased run time.

Although leaks can occur in any part of the system, the most common leak areas are couplings, hoses, tubes, fittings, pipe joints, quick disconnects, filter, regulator, and lubricator, condensate traps, valves, flanges, thread sealants, and point of use devices. Leakage rates are a function of the supply pressure in an uncontrolled system and increase with higher system pressures. Leakage rates are also proportional to the square of the orifice diameter.

### EXAMPLE

A chemical plant undertook a leak prevention program following a compressed air audit at their facility. Leaks from different orifices were found as follows: 100 leaks of 1/32″ at 90 psig, 50 leaks of 1/16″ at 90 psig, and 10 leaks of ¼″ at 100 psig. Assuming 7000 annual operating hours, an aggregate electric rate of $0.05/kWh, and compressed air generation requirement of approximately 18 kW/100 cfm, potential cost savings=number of leaks×leakage rate (cfm)×kW/cfm×number of hours×$/kWh using values of the leakage rates and assuming sharp-edged orifices:

Cost savings from 1/32″ leaks=100×1.5×0.61×0.18×7000×0.05=$5,765

Cost savings from 1/16″ leaks=50×5.9×0.61×0.18×7000×0.05=$11,337

Cost savings from ¼″ leaks=10×104×0.61×0.18×7000×0.05=$39,967

Total cost savings from eliminating these leaks=$57,069. To find the cost per hr savings, we divide total cost savings by 7000 hrs. That would be a total of $8.15 per hr savings or $195.65 cents per day. Note that the savings from the elimination of just 10 leaks of ¼″ account for almost 70% of the overall savings.

In industrial systems, a good leak prevention program will include Identification, tagging of the leaks, tracking, repair and verification. The present invention should be part of this program and will help facilitate program implementation in a timely manner. After the leaks are found and repaired the system will be re-evaluated. One of the advantages of the present invention is that leaks can be plugged while the system is running on full capacity and under operating pressure. There is no need to shut down or reduce pressure to repair leaks.

Ultrasonic frequencies are used to detect leaks. They are high frequency signals that are above range of human hearing. Human hearing range is 20 Hz to 20 kHz. Ultrasound instruments sense 20 kHz to 100 kHz. High frequencies have characteristics that work differently than low frequencies in the audible range. High frequency (ultrasound) sound waves range in size from ⅛ of an inch to ⅝ of an inch. They are directional/detectable. They are localized to the source of emission. They will reflect and not penetrate solid objects making them easy to block/shield. Using a digital ultrasonic translator which provides display screens with test data including Decibel and frequency read outs. The ultrasound is detected and these sounds are then translated down into lower frequencies within the range of human hearing. They are heard through headphones and observed as intensity increments on a meter or display panel. Leaks may also be detected by scanning module or stethoscope module. The translated ultrasound samples may be recorded for further analysis. The captured sound can be analyzed using spectral analysis software.

After a leak is detected, the present invention can be deployed in a short time to fix and repair leaks. The process may take several minutes from start to finish compared to the current methods of fixing and repairing leaks. The present invention saves time, energy, scrap, manufacturing down time, labor cost.

The use of the present invention will prevent a loss of manufacturing and energy through saving energy used in the making of compressed air. It will remove the extended labor cost of fixing the leaks in the current manner as stated above. It will also remove the pressure swings and air velocity changes in the system that are normally caused by air leaks which can lead to scrap and manufacturing down time.

The cost of making the present invention will be very competitive in comparison to the costs of plant shut down or compressed air shut down. The present invention will be a viable low cost alternative to leaving your compressed air leak until the holiday shut down.

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make and use the invention, and not necessarily to limit the scope of legal protection afforded the appended claims.

The above description of the disclosed embodiments is provided to enable any person skilled in the art to make or use that, which is defined by the appended claims. The following claims are not intended to be limited to the disclosed embodiments. Other embodiments and modifications will readily occur to those of ordinary skill in the art in view of these teachings. Therefore, the following claims are intended to cover all such embodiments and modifications when viewed in conjunction with the above specification and accompanying drawings.

What is claimed is:

1. An air controller comprising:
a shield adapted to be disposed around pipes, the shield includes at least one layer having an elongated surface, the surface having at least one geometrical pattern mounted on the surface and substantially covering a portion of the surface, the pattern includes an effective number of plurality of laterally extending repeating elements, wherein the elements are directly applied to the pipes creating plurality of effective contact surfaces to control flow of air from the pipes.

2. The air controller of claim 1 further including a plurality of geometrical patterns mounted on the surface and substantially covering a portion of the surface to create effective contact surface with the pipe to seal off the pipes.

3. The air controller of claim 1 wherein the elements include uniform dimensional cubes substantially covering portions of the surface of the shield.

4. The air controller of claim 1 wherein the layer is made of nitrille rubber.

5. A patch for controlling air leaks in pneumatic pipes, the patch comprises:
at least one layer of polymers, the layer having an elongated surface, the surface having at least one pattern distributed through the surface and substantially covering a portion of the surface, the pattern includes a plurality of elements creating effective contact surfaces with pneumatic pipes to seal off air leaks.

6. The patch of claim 5 wherein the elements include cubes having different dimensions to create plurality of contact surfaces with pneumatic pipes surface to effectively seal off air leaks in the pipes.

7. The patch of claim 5 wherein the patch is made of a starting reagent that includes cyano functional groups.

8. The patch of claim 5 including plurality of elements mounted on the surface of the layer effectively surrounding the surface of the pneumatic pipes to block leakage.

9. The package of claim 8 wherein the elements include cubes of varying dimensions.

10. A device to stop air leaks in pneumatic pipes, the device comprising:
a shield adapted to be disposed around pipes, the shield includes at least one layer having an elongated surface, the surface having an effective number of plurality of laterally extending elements, wherein the elements are directly applied to air leaks in the pipes creating plurality of contact surfaces to control flow of air.

11. The device of claim 10 wherein the elements include cubes made of nitrille rubber.
